(19) United States
(12) Patent Application Publication
(10) Pub. No.: US 2024/0371004 A1
(43) Pub. Date: Nov. 7, 2024

(54) IMAGE SEGMENTATION NETWORK FOR SYNTHETIC-TO-REAL IMAGE TRANSFER

(71) Applicant: The Regents of the University of Michigan, Ann Arbor, MI (US)

(72) Inventors: Katherine Ann SKINNER, Ann Arbor, MI (US); Advaith Venkatramanan SETHURAMAN, Ann Arbor, MI (US)

(21) Appl. No.: 18/656,544

(22) Filed: May 6, 2024

Related U.S. Application Data
(60) Provisional application No. 63/464,174, filed on May 4, 2023.

(51) Int. Cl. G06T 7/11; G06T 11/00

(52) U.S. Cl. CPC G06T 7/11; G06T 11/00; G06T 2207/20081; G06T 2207/30248

(57) ABSTRACT

A system and method of generating a segmentation map for an input image, wherein the system includes at least one processor and non-transitory, computer-readable memory that, when executed using the at least one processor, causes the system to carry out the method. The method includes: generating an anomaly map based on an input image; determining a deformation prediction based on the anomaly map; and generating a segmentation map based on the anomaly map and the deformation prediction.

### TECHNICAL FIELD

This disclosure relates to methods and systems for image classification and segmentation and, more particularly, segmentation of target objects within a sonar image through use of machine learning (ML) as well as ML framework training and configuration for such segmentation.

### BACKGROUND

Finding objects submerged underwater like shipwrecks, downed airplanes, and mines is extremely difficult. The latest techniques for underwater search involve autonomous underwater vehicles (AUVs) equipped with side scan sonar. AUVs have demonstrated potential to carry out efficient, cost-effective large area surveys of marine environments to return massive amounts of data. Still, identification of submerged objects from this data is currently a manual process relying on expert knowledge for interpretation. This can take many months to complete, often requiring multiple surveys to verify potential new discoveries.

For terrestrial applications, deep learning has demonstrated tremendous success in detecting and segmenting target objects captured on land or in the air using optical sensors. This can reduce labor in manually identifying targets from images. However, deep learning for underwater object detection and segmentation with acoustic images remains a challenge. State-of-the-art deep learning methods still rely on large amounts of labeled training data. For many applications across marine robotics, it can be extremely expensive to collect and label these training datasets. Specifically, large, labeled public sonar datasets are not available because of the cost of collection and security concerns. Furthermore, even when data is available, real examples of specific target sites may not be present due to limited frequency of appearance.

Simulation has been used to provide large amounts of labeled data for training deep learning algorithms and can be leveraged to generate additional examples of rare objects or events. However, as explained more below, there exists a sim-to-real gap between the synthetic data and real data that can hinder model performance at test time (A. Sethuraman and K. A. Skinner, “Towards sim2real for shipwreck detection in side scan sonar imagery,” 3rd Workshop on Closing the Reality Gap in Sim2Real Transfer, Robotics: Science and Systems, 2022; E. Tzeng, J. Hoffman, K. Saenko, and T. Darrell, “Adversarial discriminative domain adaptation,” CoRR, vol. abs/1702.05464, 2017). Complex environmental factors like water temperature, currents, particulate concentration, and terrain properties greatly affect the sonar image formation process and are non-trivial to model. Moreover, representing the full diversity of possible sites in synthetic data can be an intractable task. Similar problems exist with respect to other sensor data in that access to training data is limited and/or there is an appreciable sim-to-real gap between synthetic and real data.

### SUMMARY

According to one aspect of the disclosure, there is provided a method of generating a segmentation map for an input image. The method includes: generating an anomaly map based on an input image; determining a deformation prediction based on the anomaly map; and generating a segmentation map based on the anomaly map and the deformation prediction.

According to various embodiments, the method may further include any one of the following features or any technically-feasible combination of some or all of the features:
the input image is used along with the anomaly map to generate the deformation prediction;
further comprising training an image segmentation network based on a synthetic image training data set;
the training includes training an anomaly prediction network and a deformation prediction network;
the synthetic image training dataset includes a plurality of synthetic images generated using a synthetic data generation process that includes a target object fracturing process;
the anomaly prediction network generates the anomaly map based on the input image through use of a student teacher network having a student encoder and a teacher encoder;
the deformation prediction network generates the deformation prediction based on inputting the anomaly map and the input image into the deformation prediction network;
the input image is a sonar image;
the sonar image is a side scan sonar image;
the segmentation map indicates whether a portion of the input image corresponds to a shipwreck; and/or
the method is performed by a computer system having at least one processor and memory storing computer instructions that, when executed by the at least one processor, cause the method to be performed.

According to another aspect of the disclosure, there is provided a method of generating a synthetic image training dataset for training an image segmentation network. The method includes: generating a simulated environment having a target object within a target environment; generating simulated sensor readings based on the simulated environment, wherein the sensor readings pertain to the target object; generating a fractured representation of the target object based on the sensor readings; and compositing an image based on the fractured representation of the target object.

According to various embodiments, the method may further include any one of the following features or any technically-feasible combination of some or all of the features:
the generating step includes determining a deformation field that dictates how pixels of a non-fractured image generated based on the sensor readings are modified relative to the image having the fractured representation of the target object;
the target object is a ship or marine vehicle;
the simulated sensor readings form the non-fractured image;
further comprising generating a segmentation mask for the image that is composited based on the fractured representation of the target object;
the segmentation mask indicates whether pixels of the image correspond to the target object; and/or
the method is performed by a computer system having at least one processor and memory storing computer instructions that, when executed by the at least one processor, cause the method to be performed.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating an overview of anomaly detection and a deformation prediction proxy task for minimizing the sim-to-real gap during inference;

FIG. 2 is a block diagram and flowchart illustrating a synthetic data generation process, according to one embodiment;

FIG. 3 is a block diagram and flowchart illustrating a network development and training process, according to one embodiment;

FIG. 4 is a block diagram and flowchart illustrating an anomaly prediction network, according to one embodiment;

FIG. 5 is a block diagram and flowchart illustrating a deformation prediction network as well as other components of the image segmentation network, according to one embodiment; and

FIG. 6 is a method of generating a segmentation map for an input image, according to one embodiment.

### DETAILED DESCRIPTION

An image segmentation method and system are provided herein, generally, and, more specifically, there is provided an image segmentation framework for zero-shot segmentation of real images where the framework is trained using simulated data. As discussed above, finding target objects, especially downed and/or fractured objects such as shipwrecks, sparsely scattered over a large terrain, such as the ocean or sea floor, proves challenging; this is true even when applying newly-developed automated techniques, such as deep learning techniques, which generally use classifiers for semantically segmenting the inputted images so that target objects, such as shipwrecks, may be identified. Training such classifiers requires access to training data, and real data for such training is simply not available for many applications, such as those in which sonar images are scanned to find shipwrecks on the ocean or sea floor; as used herein, “ocean floor” refers to floors of all types of natural bodies of water, including, for example, seas, lakes, rivers, and streams.

The image segmentation method and system discussed herein enable semantic segmentation of input images, such as sonar images, using a machine learning (ML) classifier, such as one based on a convolutional neural network (CNN), that is specially trained for identifying objects (referred to as “target objects”) within their environment (referred to as the “target environment”) (e.g., shipwrecks on the ocean floor) where access to real training images of target objects within the target environment is limited. Accordingly, embodiments of the present disclosure are directed to addressing the problem of object segmentation when there is no access to examples of a target object during training—i.e., zero shot segmentation. The present embodiments are focused on an application relevant to marine robotics and marine archaeology—detection and segmentation of novel shipwreck sites in side scan sonar imagery—however, it will be appreciated that the teachings herein may be adapted to other sensor-based image classification or segmentation scenarios.

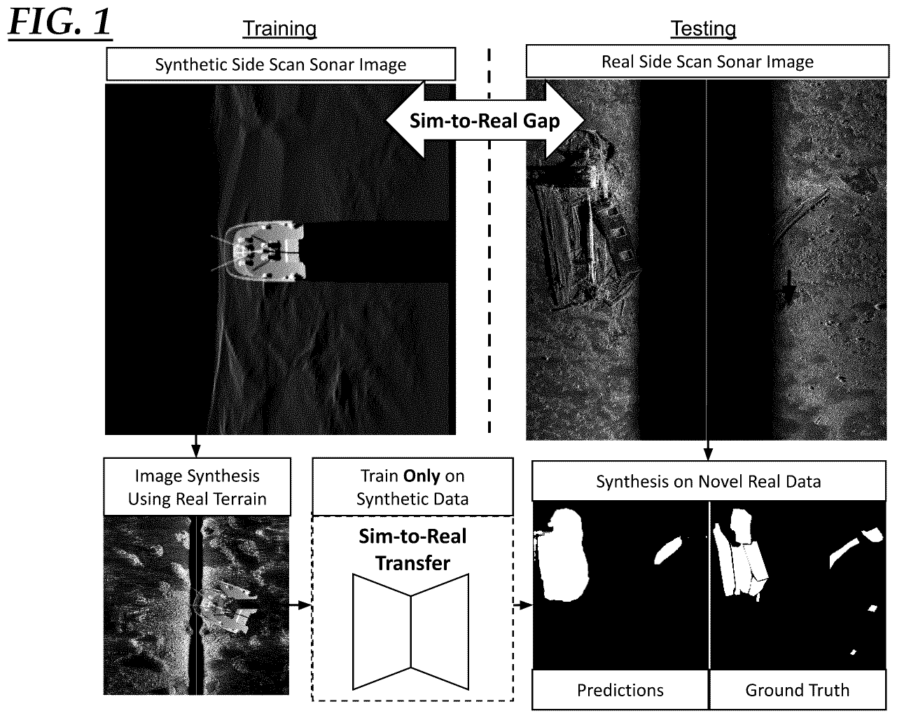

With reference to FIG. 1, there is shown an automated, deep learning framework for performing shipwreck segmentation that does not need access to real shipwreck data during training. In embodiments, the system includes a physics-based side scan sonar generation process that creates realistic but synthetic sonar imagery of shipwreck sites, as well as a ML network architecture that exploits anomaly detection and deformation prediction to better generalize to real survey sites, which results in an automated ML-based framework that uses a classifier to semantically segment real (i.e., captured with a sensor, such as a sonar sensor or camera) image data and/or to otherwise identify target objects within the target environment as captured by the image data. This framework (the “disclosed framework”) was validated with extensive experiments using a dataset of real sonar images of shipwrecks collected with an autonomous underwater vehicle (AUV) in Thunder Bay National Marine Sanctuary (TBNMS). According to embodiments, the disclosed framework provides a significant improvement in segmentation performance for the shipwreck class over state-of-the-art baselines in unsupervised anomaly detection, semantic segmentation, and unsupervised domain adaptation.

FIG. 1 depicts an overview of the disclosed framework and method, which leverages anomaly detection and a deformation prediction proxy task for minimizing the sim-to-real gap during inference. Note the gap between sonar images produced in simulation and those captured from the field. In embodiments, the disclosed framework does not see any real shipwreck sites during training and can generalize to novel real shipwreck sites seen during inference.

Anomaly detection is a popular solution when access to labeled training data is restricted and the configuration of objects of interest is ill-defined. These algorithms can use normal examples for training and detect anomalies during test time. However, anomaly detection algorithms can have high false-positive rates when used in unstructured environments, such as those underwater. Additionally, these methods detect general anomalies and do not provide insight on the presence of specified target objects.

The majority of work in object detection for sonar imagery involves fine-tuning existing object detection algorithms on real, labeled sonar imagery (D. Einsidler, M. Dhanak, and P.-P. Beaujean, “A deep learning approach to target recognition in side-scan sonar imagery,” in OCEANS 2018 MTS/IEEE Charleston, 2018, pp. 1-4; P. Feldens, A. Darr, A. Feldens, and F. Tauber, “Detection of boulders in side scan sonar mosaics by a neural network,” Geosciences, vol. 9, no. 4, 2019; D. Yang, C. Wang, C. Cheng, G. Pan, and F. Zhang, “Semantic segmentation of side-scan sonar images with few samples,” Electronics, vol. 11, no. 19, 2022; N. Nayak, M. Nara, T. Gambin, Z. J. Wood, and C. M. Clark, “Machine learning techniques for auv side-scan sonar data feature extraction as applied to intelligent search for underwater archaeological sites,” in International Symposium on Field and Service Robotics, 2019). These works have access to expert-labeled side scan sonar data for training, which is expensive and time consuming to collect. The unique nature of side scan sonar imagery has also motivated the development of specialized network architectures: A. Burguera and F. Bonin-Font, “On-line multi-class segmentation of side-scan sonar imagery using an autonomous underwater vehicle,” Journal of Marine Science and Engineering, vol. 8, no. 8, 2020; and D. Yang, C. Cheng, C. Wang, G. Pan, and F. Zhang, “Side-scan sonar image segmentation based on multi-channel cnn for auv navigation,” Frontiers in Neurorobotics, vol. 16, 2022. The first, Burguera and Bonin-Font, uses an encoder/decoder architecture to perform segmentation of side scan images, whereas the latter, Yang et al., uses a multi-channel segmentation network to segment terrain classes in side scan sonar. Both networks are trained using supervised learning on labeled datasets. The present system and method instead leverages synthetic data generation to mitigate the need for collecting and labeling sonar datasets for training, at least in embodiments. In such embodiments, since the network is trained using only synthetic data, the system and method may be used to train and condition the network for generalization to unseen environments and for minimization of the sim-to-real gap.

The disclosed system and method uses synthetic image data that is generated for training the network. The image formation process for side scan sonars can be approximated using ray-tracing and does not require access to real, labeled sonar data (J. Bell, “Simulation and analysis of synthetic sidescan sonar images,” IEE Proceedings—Radar, Sonar and Navigation, vol. 144, pp. 219-226(7), August 1997). However, the lack of diverse terrains and consideration of environmental factors can cause subpar object detection performance (A. Sethuraman and K. A. Skinner, “Towards sim2real for shipwreck detection in side scan sonar imagery,” 3rd Workshop on Closing the Reality Gap in Sim2Real Transfer, Robotics: Science and Systems, 2022, J. Shin, S. Chang, M. Bays, J. Weaver, T. Wettergren, and S. Ferrari, “Synthetic sonar image simulation with various seabed conditions for automatic target recognition,” 2022). Current approaches to improving realism in synthetic sonar data generation include: Generative Adversarial Networks (E.-h. Lee, B. Park, M.-H. Jeon, H. Jang, A. Kim, and S. Lee, “Data augmentation using image translation for underwater sonar image segmentation,” PLOS ONE, vol. 17, 08 2022; Y. Jiang, B. Ku, W. Kim, and H. Ko, “Side-scan sonar image synthesis based on generative adversarial network for images in multiple frequencies,” IEEE Geoscience and Remote Sensing Letters, vol. 18, no. 9, pp. 1505-1509, 2021), style transfer (“Deep learning based object detection via style-transferred underwater sonar images,” IFAC-PapersOnLine, vol. 52, no. 21, pp. 152-155, 2019, 12th IFAC Conference on Control Applications in Marine Systems, Robotics, and Vehicles CAMS 2019; S. Lee, B. Park, and A. Kim, “Deep learning from shallow dives: Sonar image generation and training for underwater object detection,” CoRR, vol. abs/1810.07990, 2018), ray-tracing (J. Bell, “Simulation and analysis of synthetic sidescan sonar images”), and image composition techniques (J. M. Topple and J. A. Fawcett, “Minet: Efficient deep learning automatic target recognition for small autonomous vehicles,” IEEE Geoscience and Remote Sensing Letters, vol. 18, no. 6, pp. 1014-1018, 2021; Q. Ge, F. Ruan, B. Qiao, Q. Zhang, X. Zuo, and L. Dang, “Sidescan sonar image classification based on style transfer and pre-trained convolutional neural networks,” Electronics, vol. 10, no. 15, 2021; D. Dwibedi, I. Misra, and M. Hebert, “Cut, paste and learn: Surprisingly easy synthesis for instance detection,” in Proceedings of (ICCV) International Conference on Computer Vision, October 2017, pp. 1310-1319). For example, E.-h. Lee et al. uses a Pix2Pix image translation network trained on real, labeled data to convert from binary masks to objects in sonar imagery. “Deep learning based object detection via style-transferred underwater sonar images,” IFAC-PapersOnLine, vol. 52, no. 21, pp. 152-155, 2019, 12th IFAC Conference on Control Applications in Marine Systems, Robotics, and Vehicles CAMS 2019 uses depth images generated in simulation and then uses a style transfer network to emulate different environments like pool and ocean.

Instead of using style transfer, the disclosed method, according to embodiments, uses physics-based rendering to better simulate the side scan sonar image formation process. Another method for sonar image synthesis is “cutting and pasting”; see references noted above in connection with “image composition techniques”. For example, Ge et al. uses style transfer networks and cutting and pasting to produce synthetic side scan sonar images; although effective, this method also requires real examples of objects in side scan sonar imagery to train the style transfer network, whereas the disclosed method does not require real examples of the target objects, at least in embodiments. The disclosed framework leverages image synthesis techniques and physics-based rendering concepts but adapts them for shipwreck segmentation in side scan sonar imagery, and provides a method for simulating shipwreck debris using deformation fields, which are used as a proxy learning task for the disclosed method, at least according to embodiments.

Domain adaptation is a method for modifying a network trained in a source domain (e.g., simulated data) to perform inference in a target domain (e.g., real data). Relevant to this work is Unsupervised Domain Adaptation (UDA), where there are no object labels in the target domain. Recently, L. Hoyer, D. Dai, and L. Van Gool, “Hrda: Context-aware high resolution domain-adaptive semantic segmentation,” 2022 proposed HRDA, a state-of-the-art UDA method for adaptation across different object sizes. Still, unsupervised domain adaptation requires a representative set of target objects to be present in both synthetic and real data for training, which may not be possible for rare targets.

Zero shot segmentation is a segmentation paradigm developed to reduce the need for costly pixel-wise segmentation labels (M. Bucher, T. Vu, M. Cord, and P. P'erez, “Zero-shot semantic segmentation,” CoRR, vol. abs/1906.00817, 2019; Z. Gu, S. Zhou, L. Niu, Z. Zhao, and L. Zhang, “From pixel to patch: Synthesize context-aware features for zero-shot semantic segmentation,” CoRR, vol. abs/2009.12232, 2020). Zero shot segmentation generalizes segmentation learned on seen classes from a training dataset to unseen classes during test time. According to embodiments, such as the exemplary illustrated embodiment discussed below, there is access to labeled objects in a specific domain and there is a desire to generalize to another domain, and the classes remain the same. A relatively new field called zero shot unsupervised domain adaptation explores the problem of adapting a model learned in a specific domain to another domain without any examples from the target domain. Models like PODA are prompted by text descriptions of the target domain and are able to adapt features learned in the source domain (M. Fahes, T.-H. Vu, A. Bursuc, P. Pérez, and R. de Charette, “PØda: Prompt-driven zero-shot domain adaptation,” 2022). The disclosed framework does not require prompts or text description, and instead leverages synthetic data for sim-to-real transfer, at least according to the exemplary illustrated embodiment discussed below.

Unsupervised anomaly detection methods train only on a normal set of images and identify anomalies in test images by producing an anomaly score at the image or pixel level. DeSTSeg is an anomaly detection method that uses a student-teacher paradigm to segment anomalous regions of images (X. Zhang, S. Li, X. Li, P. Huang, J. Shan, and T. Chen, “Destseg: Segmentation guided denoising student-teacher for anomaly detection,” 2022). DeSTSeg first generates synthetic anomalies then trains a supervised segmentation network. However, the synthetic anomalies are restricted to small cracks and defects often found in an industrial setting, not the complex shapes of shipwrecks as in our problem. The current state-of-the-art method, PatchCore, uses a memory bank to store normal features (K. Roth, L. Pemula, J. Zepeda, B. Schölkopf, T. Brox, and P. Gehler, “Towards total recall in industrial anomaly detection,” 06 2021). Finally, PatchCore provides an anomaly score by reporting a distance metric between test features and a subsampled memory bank. The disclosed framework uses anomalous features and refines them in a manner relevant to the segmentation task, at least in embodiments. It was shown that this ability to generalize to unseen features is useful for minimizing the sim-to-real gap.

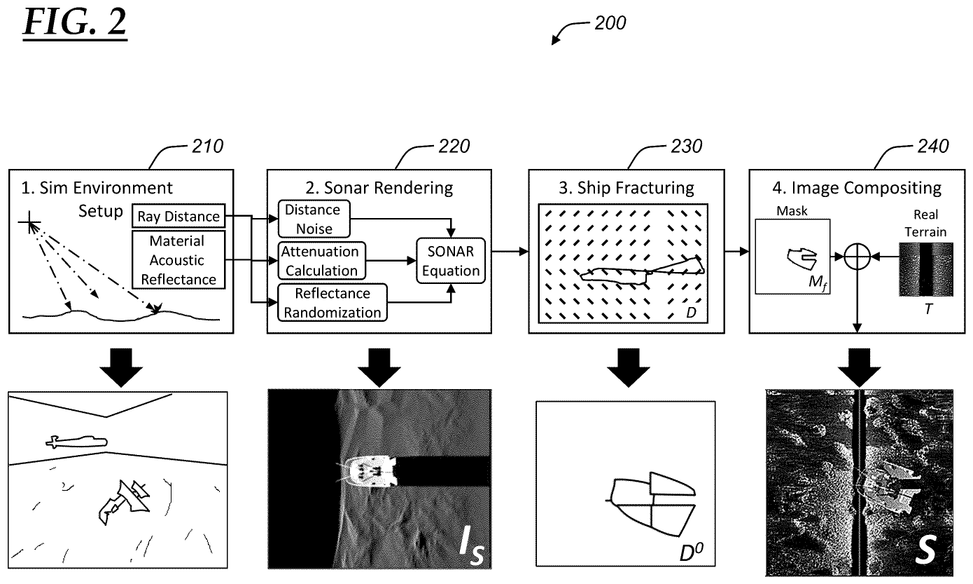

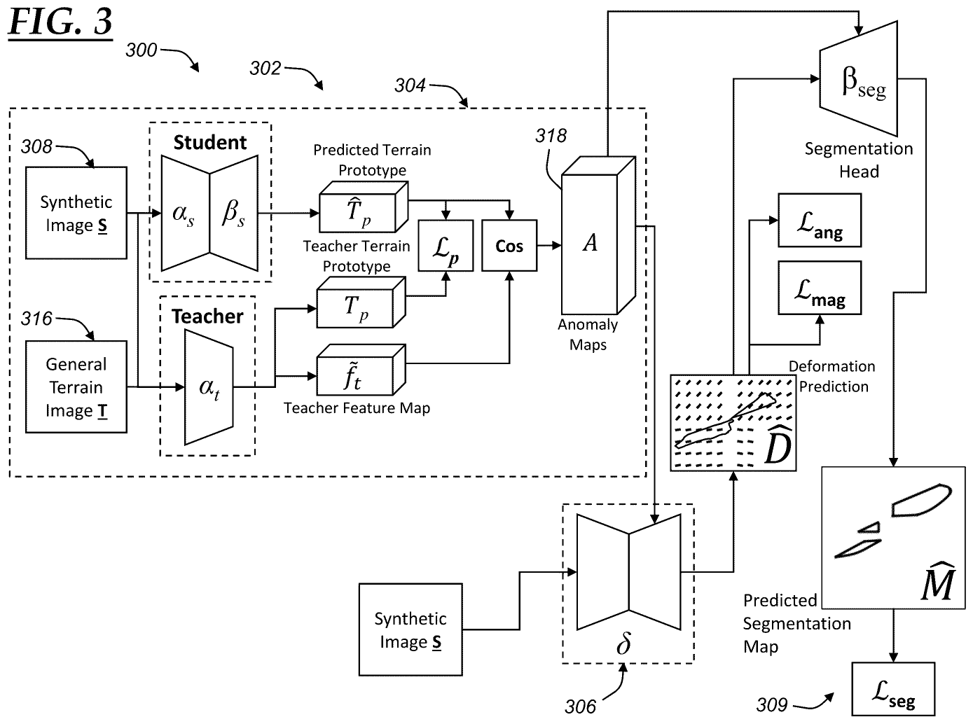

With reference to FIGS. 2-3, the disclosed system and method include two main components: synthetic data generation (FIG. 2) and network development and training (FIG. 3). First, synthetic side scan sonar data is generated for training using physics-based rendering. Then, the target objects, such as ships or boats, are fractured using a deformation field and are then composited onto images of real terrain. The disclosed segmentation network is trained completely in simulation, at least in the present embodiment. Finally, inference on real side scan sonar images with no additional fine-tuning is performed.

The process 200 begins with step 210, wherein a simulation environment is setup. Since side scan sonar is a time of flight sensor that measures the intensity of acoustic return at a given range, it can be approximated using raytracing. According to one exemplary setup, BLAINDER is used to develop a side scan sonar simulation system within the Blender graphics environment (S. Reitmann, L. Neumann, and B. Jung, “Blainder—a blender ai addon for generation of semantically labeled depth-sensing data,” Sensors, vol. 21, no. 6, 2021; B. O. Community, “Blender—a 3d modelling and rendering package,” Blender Foundation, Stichting Blender Foundation, Amsterdam, 2018), modeled after the side scan sonar used for real experiments. The Edgetech 2205 side scan sonar used in our field experiments has a 3 dB beamwidth of θb=0.36°. Rays are traced accordingly from the sensor origin within a range of azimuth Θ∈

$$[ - \frac{{θ}_{b}}{2} , \frac{{θ}_{b}}{2} ]$$

and elevation angles Φ∈[90°, 180°]. According to one embodiment, the simulation environment consists of 3D meshes of ships, which may be BLENDER (BLEND) files or other native 3D file format, for example; the 3D ship data is obtained online from TurboSquid™, for example. Terrain with varying elevation may be generated using the ANT Landscape tool box in Blender. To mimic the variation found in real side scan sonar data, domain randomization (J. Tobin, R. Fong, A. Ray, J. Schneider, W. Zaremba, and P. Abbeel, “Domain randomization for transferring deep neural networks from simulation to the real world,” CoRR, vol. abs/1703.06907, 2017) is employed. The following parameters were randomized: acoustic reflectance, terrain elevation, ship location, ship scale, ship orientation. These parameters are sampled uniformly from fixed ranges. After the simulation environment is setup, the process 200 continues to step 220.

In step 220, side scan sonar rendering is performed. As discussed above, with the above simulation setup, ray tracing is performed in the simulated environment. The ray traced points in the sensor frame are converted to a side scan sonar image, as discussed below according to an exemplary process. This process is similar to that of J. Bell, “Simulation and analysis of synthetic sidescan sonar images,” IEE Proceedings—Radar, Sonar and Navigation, vol. 144, pp. 219-226(7), August 1997. The sonar has a range limit of dₘₐₓ meters and meters per pixel resolution of

$$Δ = \frac{{d}_{max}}{W} .$$

A single simulated sonar ping is defined as the set of all the rays [symbol] traced through azimuth and elevation angle ranges, (Θ,Φ). A single ray from Blender rᵢ∈ [symbol] provides material information, distance to intersection dᵢ, and normal information nᵢ. To calculate the intensity of the sonar return for a given ray rᵢ, we account for the propagation of sound in decibels underwater using the SONAR equation:

$${RI}_{i} = {SL}_{i} - 2 {TL}_{i} + {TS}_{i} \qquad ( Equation 1 )$$

where RIᵢ is the intensity of sound returned to the sensor, SLᵢ is the source level of the emitted acoustic pulse, and TLᵢ is the transmission loss from sound propagation through water such that TLᵢ=10 log₁₀(dᵢ), where dᵢ is the distance of the return. TS is the target strength, or sonar cross section of the object imaged. Consider the set of rays [symbol] ₚ⊂ [symbol] that terminated within a range of

$$ℬ ( p ) = [ Δ \cdot p - \frac{Δ}{2} , Δ \cdot p + \frac{Δ}{2} ]$$

meters away from the sensor, where p∈[0, W]. The acoustic returns from every ray rᵢ∈ [symbol] ₚ are accumulated into a pixel with horizontal location p. Each side scan sonar ping produces a raster line image L of resolution (1, W):

$$L ( p ) = {\sum }_{i ∈ \{ i : {r}_{i} ∈ {ℛ}_{p} \}} {RI}_{i} \qquad ( Equation 2 )$$

The simulated sensor will move through the environment and accumulate pings in the vertical axis to produce a synthetic image Iₛ in two dimensions. A segmentation mask M is also produced by the same rendering process. The process 200 continues to step 230.

In step 230, a target object fracturing is performed and, particularly in the illustrated embodiment, ship fracturing. To better simulate the destruction present at real shipwreck sites, we fragment the rendered ship. This process is illustrated in FIG. 2. A deformation field, or optical flow field dictates how pixels are translated in relation to the original image. The origin is at the center of the ship and the ship is split into 4 pieces. Since the orientation of the ship is randomized, this yields a diverse set of debris. The field is randomly generated, but all pixels within a given quadrant experience the same field. The field D∈ [symbol] ^{H×W×2} is parameterized by (r, θ) for each pixel. The radius r∈[0, rₘₐₓ] is divided into Nᵣ=10 discrete values, whereas the angle θ∈[0, 2π] is divided into N_{θ}=20 discrete values. This is used to create a one-hot representation of the magnitude and angle D^{mag}∈ [symbol] ^{H×W×N}^{ᵣ}, D^{ang}∈ [symbol] ^{H×W×N}^{_{θ}}. These are concatenated to create D°=D^{mag}⊕D^{ang}∈ [symbol] ^{H×W×D}^{_{def}}, where D_{def}=Nᵣ+N_{θ}=30. Then, the field is applied to split the ship image Iₛ in an arbitrary pattern and produces fractured image I_{f}. Let Iₛ(u, v) represent the image value at pixel location (u, v) and (r, θ)=D(u, v) represent the deformation field at the same location, then

$${I}_{f} ( u + r cos ( θ ) , v + r sin ( θ ) ) = {I}_{s} ( u , v ) \qquad Equation ( 3 )$$

The synthetic segmentation mask M is also fractured with D to produce M_{f}. The process 200 continues to step 240.

In step 240, the final synthetic image is composited. The final synthetic image S is created by compositing onto a real terrain image T with an element-wise product ⊙.

$$S = [ {M}_{f} ⊙ {I}_{f} ] + [ ( 1 - {M}_{f )} ⊙ T ] \qquad Equation ( 4 )$$

It is reasonable to assume access to real terrain images T because they are publicly available and collected during routine surveys of bodies of water. This method of fracturing the ships is more convenient compared to fracturing in 3D because it avoids re-rendering the sonar images and we can expand upon our basic deformation field in the future. The process 200 then ends.

With reference to FIGS. 3-5, there is shown a proposed image segmentation network 300. Although a side scan sonar image is gray-scale, it is reproduced to produce an input image with three (3) channels. This reduces any modification to backbone networks. Given an image I∈ [symbol] ^{H×W×3}, a segmentation map \hat{M}∈ [symbol] ^{H×W×1} is produced that has two classes: {terrain, shipwreck} or more generically {no target object, target object}. In the present embodiment, the proposed image segmentation network 300 includes an anomaly-deformation network 302, which is used to generate a segmentation output that provides a predicted segmentation of an input image. The anomaly-deformation network 302 includes an anomaly prediction network ψ: [symbol] ^{H×W×3}→ [symbol] ^{H×W×D}^{ₜ} (at 304) and a deformation prediction network δ: [symbol] ^{H×W×3}→ [symbol] ^{H×W×D}^{_{def}} (at 306). The outputs are fused to produce \hat{M}. The inductive biases the disclosed method develops are 1) the ability to identify anomalous features with respect to general terrain, and 2) the ability to discriminate anomalous features representative of our target shipwreck class to reduce false positives in shipwreck segmentation.

A process 400 for generating an image segmentation output is shown, according to an embodiment. The process 400 is illustrated by the arrows, beginning with begins with inputting a synthetic image 308 and ending with the image segmentation output 309.

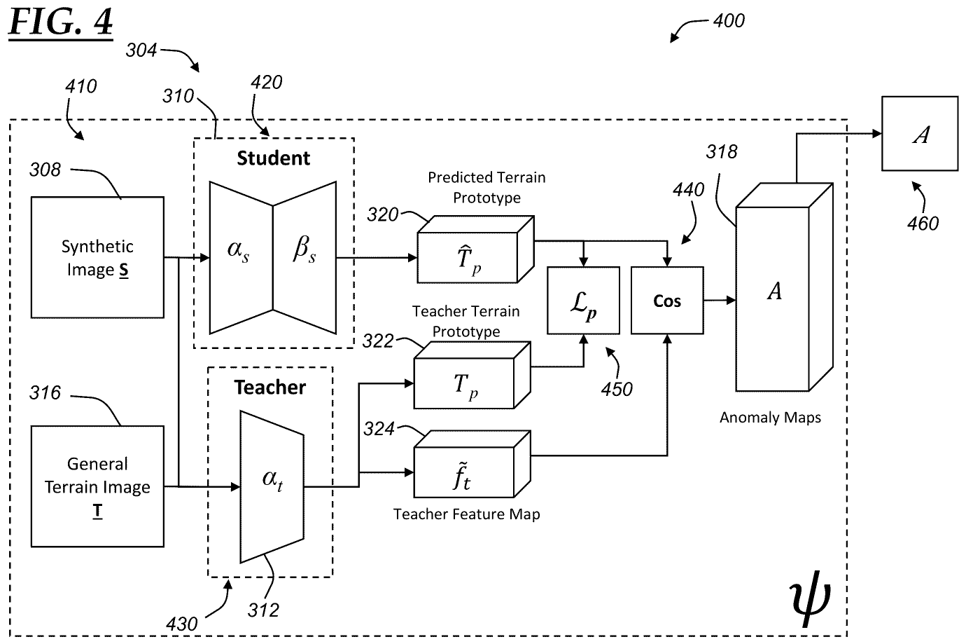

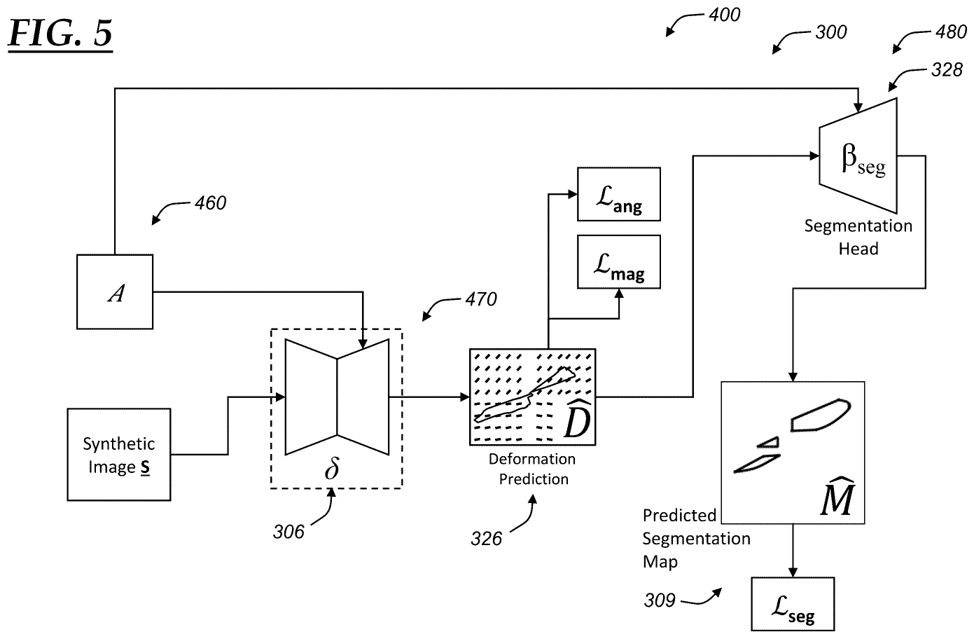

With reference to FIG. 4, there is shown the anomaly prediction network 304. According to the illustrated embodiment, the disclosed framework and method uses a student-teacher network paradigm, including a student network 310 and a teacher network 312. At a first step 410 of the process 400, the synthetic image 308 and a terrain image 316 are obtained and, specifically, in the illustrated embodiment, the synthetic image 308 is input into the student network 310 and both the synthetic image 308 and the terrain image 316 are input into the teacher network 312, and then used to generate an anomaly map 318 (as represented by A in FIGS. 4-5). Then, at steps 420 and 430, the synthetic image 308 is processed by the student network 310 to generate a student terrain prototype \hat{T}ₚ(i) (at 320), and the terrain image 316 and synthetic image 308 are processed by the teacher network 312 to generate a teacher terrain prototype 322 or Tₚ(i). Unlike previous anomaly detection techniques that computed the cosine distance between student and teacher features in the same spatial location, the disclosed framework produces a tensor [symbol] ^{1×1×c} that summarizes the general terrain in an image. Then, at step 440, at least according to the illustrated embodiment, the cosine distance between the predicted terrain prototype 320 and the teacher's entire feature map 324 is computed.

The illustrated anomaly prediction network 304 (ψ) is composed of a student encoder αₛ, a student decoder βₛ, and a teacher encoder at. In the illustrated embodiment, the teacher network 312 is frozen and does not receive gradient updates. As mentioned above, in step 420, a synthetic image 308 (S) is passed through the student encoder αₛ and the student decoder βₛ. The student decoder βₛ produces feature maps fₛ(i), i∈[1, Dₗ] at varying resolutions, and, then, a global average pooling (GAP) layer is used on the spatial dimensions of fₛ(i) to produce the student terrain prototype \hat{T}ₚ(i) (at 320). This student terrain prototype 320 is supervised by the teacher encoder αₜ, which is used to generate the teacher terrain prototype 322. The teacher terrain prototype 322 is used to minimize loss of the student network 310. Note that the teacher network 312 is fed the regular terrain image 316 (T) without any objects. The teacher encoder αₜ(T) produces feature maps fₜ(i), i∈[1, Dₗ]. Similarly, global average pooling is used to construct the teacher terrain prototype 322 or Tₚ(i) based on the produced feature maps fₜ(i). Finally, at step 450, training is performed and, particularly, a mean squared error (MSE) loss is used to supervise the student:

$${ℒ}_{p} = {\sum }_{i = 1}^{{D}_{i}} {‖ {\hat{T}}_{p} ( i ) - {T}_{p} ( i ) ‖}_{2}^{2} \qquad Equation ( 5 )$$

In order to compute the anomaly map A(i) at a given depth i, the teacher encoder is fed the synthetic image S. This produces a teacher feature map \tilde{f}ₜ(i). The cosine distance between each \tilde{f}ₜ(i) and \hat{T}ₚ(i) is used as an anomaly score:

$$A ( i ) = 1 - \frac{{\hat{T}}_{p} ( i ) \cdot {\tilde{f}}_{f} ( i )}{\vert {\hat{T}}_{p} ( i ) \vert \vert {\tilde{f}}_{t} ( i ) \vert} \qquad Equation ( 6 )$$

Intuitively, a smaller cosine distance is observed when the student terrain prototype 320 is compared to terrain features of the teacher feature map 324 but higher distance when compared to anomalous debris features of the teacher feature map 324. Since the input to the student network 310 is the synthetic image 308 (or S) and is supervised by the teacher terrain prototype 322 or Tₚ(i), the student network 310 learns to ignore any objects and focuses on summarizing the terrain effectively. Note that teacher terrain prototype 322 or Tₚ is not needed for inference and is only used for supervised training, at least according to the depicted embodiment. The process 400 continues to step 460.

With reference to FIG. 5, there is shown the deformation prediction network 306, as well as other components of the image segmentation network 300. At step 460, the anomaly map A is obtained, which is a result of generating the anomaly map A using the anomaly prediction network 304, at least in the illustrated embodiment. At step 470, the deformation prediction network 306 generates a deformation prediction output 326 based on using the anomaly map A as the input. The deformation prediction network 306 or δ enforces a proxy task to specifically learn to identify anomalous features that are representative of debris fields at shipwreck sites. Since the network 306 must predict the deformation field D that turned intact image Iₛ into fractured image I_{f}, the network 306 first identifies parts of a broken ship, and then learns the relation between the different pieces. The decoder also concatenates the anomaly maps at varying resolutions A(i), i∈[1, Dₗ] to the skip connections. This allows the anomaly prediction to aid the deformation prediction. \hat{D}∈ [symbol] ^{H×W×D}^{_{def}} is composed of a magnitude \hat{D}^{mag}∈ [symbol] ^{H×W×D}^{ᵣ} and angle \hat{D}^{ang}∈ [symbol] ^{H×W×D}^{_{θ}} prediction for each pixel. These predictions are supervised using a cross entropy loss using ground truth D°:

$${ℒ}_{mag} = - {\sum }_{c = 1}^{{D}_{r}} {\sum }_{h = 1}^{H} {\sum }_{w = 1}^{W} {D}_{hwc}^{mag} log {\hat{D}}_{hwc}^{mag} \qquad Equation ( 7 )$$

$${ℒ}_{ang} = - {\sum }_{c = 1}^{{D}_{θ}} {\sum }_{h = 1}^{H} {\sum }_{w = 1}^{W} {D}_{hwc}^{ang} log {\hat{D}}_{hwc}^{ang} \qquad Equation ( 8 )$$

After the deformation prediction is made in step 470, the process 400 continues to step 480.

In step 480, a predicted segmentation map is generated based on the deformation prediction and the anomaly map A. The predicted segmentation map is generated by a segmentation head or fusion network 328, which uses the anomaly map A and the deformation prediction as input. The two branches are fused with a 1×1 convolutional decoder β_{seg}. All layers A(i) are bilinearly interpolated to a resolution of (H, W) and concatenated along the channel dimension to produce feature volume F∈ [symbol] ^{H×W×D}^{ₗ}. Finally, the segmentation map is given by \hat{M}=β_{seg}(F). The segmentation output is supervised by a binary cross entropy loss:

$${ℒ}_{seg} = - {\sum }_{h = 1}^{H} {\sum }_{w = 1}^{W} {( {M}_{f} )}_{hw} {log ( \hat{M} )}_{hw} \qquad Equation ( 9 )$$

The final loss becomes:

$$ℒ = {ℒ}_{mag} + {ℒ}_{ang} + {ℒ}_{p} + {ℒ}_{seg} \qquad Equation ( 10 )$$

The process 400 ends.

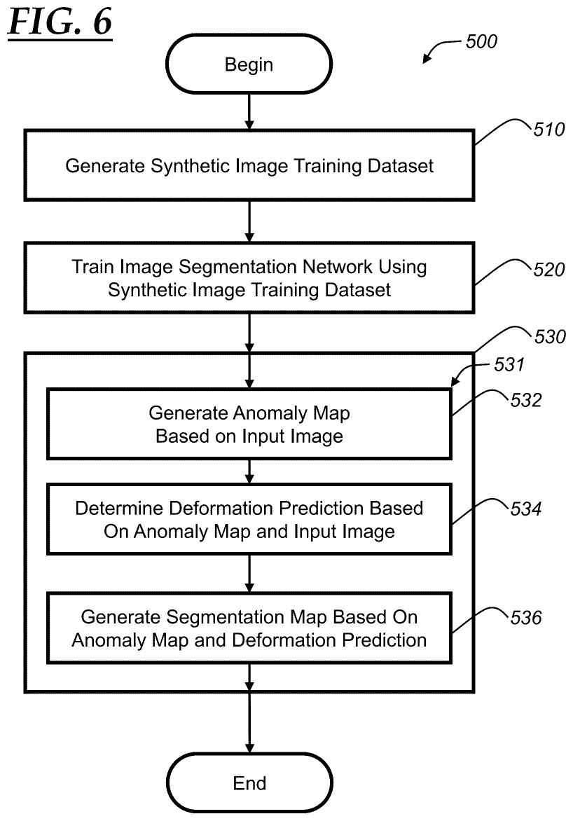

With reference to FIG. 6, there is shown a method 500 of generating a segmentation map for an input image, according to one embodiment. The method 500 begins with step 510, wherein a synthetic image training dataset is generated. The synthetic image training dataset includes a plurality of synthetic images, each of which may be generated using the process 200 (FIG. 2). In embodiments, the synthetic image training data set further includes labels for each of the synthetic images, and the labels may be segmentation maps, such as the one generated as a part of the step 240 discussed above. The method 500 continues to step 520.

In step 520, a segmentation network architecture is trained using the synthetic image training dataset. As discussed above in connection with the process 400, the image segmentation network 300 includes various encoders and decoders that aid in generating a segmentation map for a given input image. The encoders and decoders, such as the student network 310, the teacher network 312, the deformation network 306, and the segmentation head or fusion network 328, are trained using synthetic images of the synthetic image training dataset. The method 500 continues to step 530.

In step 530, the trained image segmentation network is used to generate a segmentation map based on an input image. In embodiments, this step includes using the trained image segmentation network to segment the input image, such as for purposes of identifying a shipwreck based on an input side scan sonar image. According to embodiments, this step 530 includes performing an image segmentation inference process 531 that generates a segmentation map, and this process 531 may include: a sub-step of 532 inputting the input image into an anomaly prediction network to generate an anomaly map for the input image, a sub-step 534 of determining a deformation prediction based on the anomaly map, and a sub-step 536 of generating the segmentation map based on the anomaly map and the deformation prediction. For example, at sub-step 532, the input image is passed into the student network 310 and the teacher network 312 so as to generate an anomaly map 318. Then, at sub-step 534, the anomaly map is input into the deformation prediction network 306 along with the input image so as to generate a deformation prediction. Subsequently, at sub-step 536, the generated deformation prediction is passed along with the anomaly map into the segmentation head or fusion network 328, which then produces a segmentation map. The method 500 ends.

It will be appreciated that the above-discussed system(s) and method(s) may be implemented using a computer system, such as one having at least one processor and memory storing computer instructions that, when executed by the at least one processor, cause the method (or at least one or more portions, steps, or operations discussed herein) to be performed. Thus, the image segmentation network discussed herein, including the exemplary network 300, may be implemented by the computer system. Moreover, according to embodiments, this computer system, as configured to implement the image segmentation network discussed herein, may be comprised of various computer components and sub-systems, which may be co-located or remotely located from one another, according to embodiments.

Any processor or electronic processor discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the memory discussed herein may be implemented as any suitable type of non-transitory memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of generating a segmentation map for an input image, comprising:
generating an anomaly map based on an input image;
determining a deformation prediction based on the anomaly map; and
generating a segmentation map based on the anomaly map and the deformation prediction.

2. The method of claim 1, wherein the input image is used along with the anomaly map to generate the deformation prediction.

3. The method of claim 1, further comprising training an image segmentation network based on a synthetic image training data set.

4. The method of claim 3, wherein the training includes training an anomaly prediction network and a deformation prediction network, wherein the synthetic image training dataset includes a plurality of synthetic images generated using a synthetic data generation process that includes a target object fracturing process.

5. The method of claim 4, wherein the anomaly prediction network generates the anomaly map based on the input image through use of a student teacher network having a student encoder and a teacher encoder.

6. The method of claim 4, wherein the deformation prediction network generates the deformation prediction based on inputting the anomaly map and the input image into the deformation prediction network.

7. The method of claim 1, wherein the input image is a sonar image.

8. The method of claim 7, wherein the sonar image is a side scan sonar image.

9. The method of claim 8, wherein the segmentation map indicates whether a portion of the input image corresponds to a shipwreck.

10. The method of claim 1, wherein the method is performed by a computer system having at least one processor and memory storing computer instructions that, when executed by the at least one processor, cause the method to be performed.

11. A method of generating a synthetic image training dataset for training an image segmentation network, comprising:
generating a simulated environment having a target object within a target environment;
generating simulated sensor readings based on the simulated environment, wherein the sensor readings pertain to the target object;
generating a fractured representation of the target object based on the sensor readings; and
compositing an image based on the fractured representation of the target object.

12. The method of claim 11, wherein the generating step includes determining a deformation field that dictates how pixels of a non-fractured image generated based on the sensor readings are modified relative to the image having the fractured representation of the target object.

13. The method of claim 12, wherein the target object is a ship or marine vehicle.

14. The method of claim 13, wherein the simulated sensor readings form the non-fractured image.

15. The method of claim 14, further comprising generating a segmentation mask for the image that is composited based on the fractured representation of the target object.

16. The method of claim 15, wherein the segmentation mask indicates whether pixels of the image correspond to the target object.

17. The method of claim 11, wherein the method is performed by a computer system having at least one processor and memory storing computer instructions that, when executed by the at least one processor, cause the method to be performed.
